(19) United States
(12) Patent Application Publication
(10) Pub. No.: US 2013/0256355 A1
(43) Pub. Date: Oct. 3, 2013

(54) Hands-Free Umbrella Holder

(71) Applicant: Gina M. Gatto-Weising, Harker Heights, TX (US)

(72) Inventor: Gina M. Gatto-Weising, Harker Heights, TX (US)

(21) Appl. No.: 13/828,521

(22) Filed: Mar. 14, 2013

Related U.S. Application Data
(60) Provisional application No. 61/610,889, filed on Mar. 28, 2012.

(51) Int. Cl. B60R 11/00

(52) U.S. Cl. CPC B60R 11/00
USPC 224/482

(57) ABSTRACT

An automobile-mountable umbrella holder selectively attaches to an automobile window, for example, with a releasable heavy duty suction mount. An umbrella holder receptacle provides means to tighten the receptacle to the umbrella handle to maintain an open umbrella in an upright position. An armature connects the umbrella holder to the window mount and articulates so that the position of umbrella can be adjusted to suit the needs of the user.

### TECHNICAL FIELD

This disclosure relates generally to umbrella holders and more particularly to apparatuses and methods for a selectively mountable umbrella holder useful when getting in and out of an automobile.

### BACKGROUND

Few tasks are more aggravating than to try to extricate a child from the child seat of an automobile in the rain while holding an umbrella. Even taking groceries bags from the back seat of an automobile can be a challenge when one hand is tied up holding the umbrella. The essential problem is that one cannot let go of the umbrella in the rain, no matter what else one needs to do, without defeating the purpose of using the umbrella in the first place, which is to stay dry.

In addition to parents and the encumbered, the handicapped or injured who uses a wheelchair, motorized scooter, crutches and the like (and their caretakers), would appreciate a hands-free umbrella holder for use during inclement weather during ingress or egress form a vehicle.

Previous attempts to solve this problem have been made. Stallings, Jr. (U.S. Pat. No. 7,967,274) describes an umbrella holder mounted to the interior of an automobile window. The umbrella holder of Stallings, Jr., however lacks some of the advantageous features of the present disclosure. For example, Stallings, Jr. fails to disclose a unitary mounting mechanism to selectively attach the holder to the window, providing instead a plate having a plurality of suction cups. Such an assembly runs the risk that the suction cups will become detached form plate or otherwise become unsuitable. Additionally, Stallings, Jr. does not provide and articulating armature that connects the holder to the window mount, nor is a tightening mechanism provided to secure the umbrella in an upright position in the holder.

There remains, therefore, a need for an umbrella holder that can be selectively mounted to an automobile and that can secure an open umbrella in an upright position while one performs tasks proximate to the vehicle.

### SUMMARY

An automobile-mountable umbrella holder selectively attaches to an automobile window, for example, with a releasable heavy duty suction mount. An umbrella holder receptacle provides means to tighten the receptacle to the umbrella handle to maintain an open umbrella in an upright position. An armature connects the umbrella holder to the window mount and articulates so that the position of umbrella can be adjusted to suit the needs of the user.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a perspective side view of an umbrella holder of the present disclosure mounted to the interior of an automobile window.

FIG. 2 is a perspective front view of an umbrella holder of the present disclosure.

Unless otherwise indicated, the same reference number in the various views refers to the same element.

### DETAILED DESCRIPTION

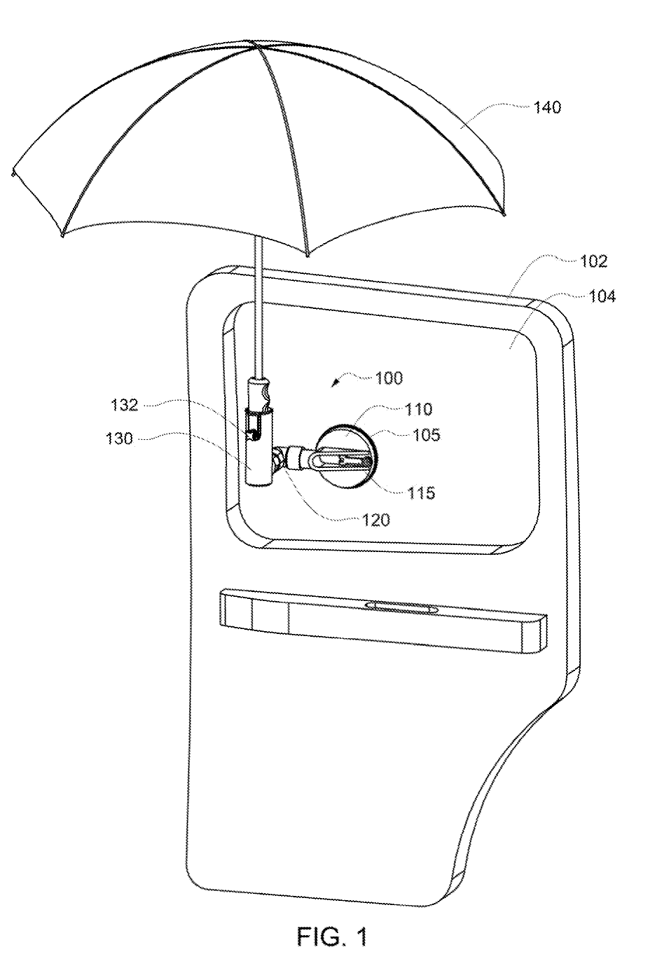

Referring to FIG. 1 of the drawings, FIG. 1 is a perspective side view of an umbrella holder of the present disclosure mounted to the interior of an automobile window. Reference numeral 100 generally designates an umbrella holder assembly embodying features of the present disclosure. Assembly 100 is mounted to the interior side of automobile door 102 on window 104. The system 100 includes attachment means 110, armature 120, and holder 130.

Specific embodiments of attachment means 110 have a suction cup 105 of rubber or other material that forms a seal on window 104 of sufficient strength to support the weight of umbrella 140 in holder 130. Attachment means 110 provides release mechanism 115 in specific embodiments whereby assembly 100 can be attached or detached from window 104. In the view of FIG. 1, the release mechanism 115 is in the closed (or attached) position.

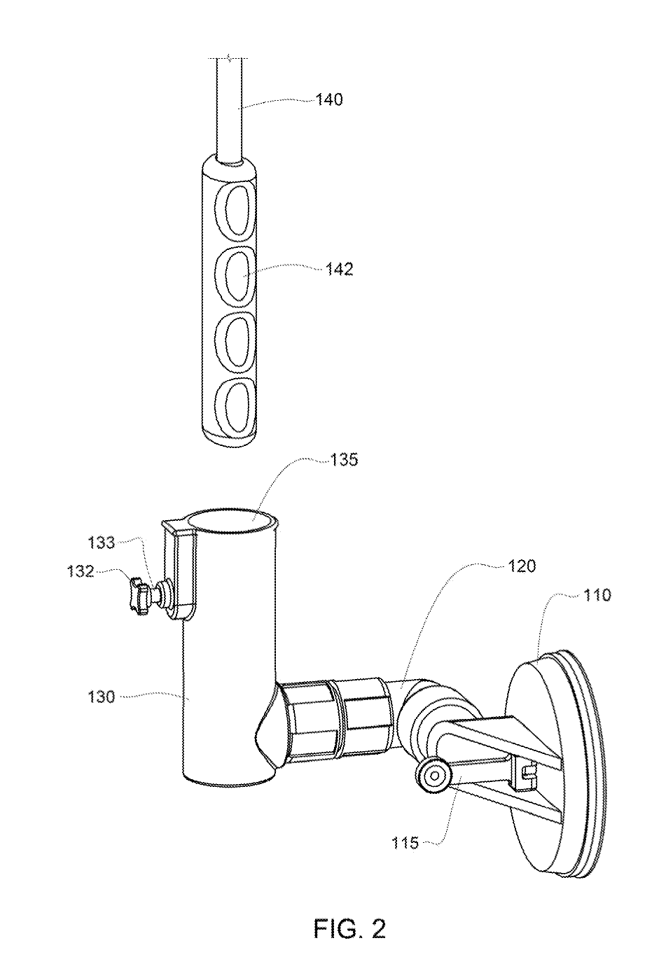

FIG. 2 is a perspective front view of an umbrella holder of the present disclosure. In the view of FIG. 2, the released mechanism 115 is in the open (or release) position. Holder 130 provides receptacle 135 mounted on armature 120. Receptacle 135 has a diameter sufficiently great to accommodate the width umbrella handle 142. Tightener 132 provides pin 133 that can be selectively tightened onto umbrella handle 142 to secure umbrella 140 in an upright position, and can be selectively loosened to release umbrella handle 142 from receptacle 135. Armature 120 which connects attachment means 110 and holder 130 is articulated in specific embodiments. An articulated armature allows a user to adjust the position of the umbrella to maximize its beneficial effect and to selectively fix the umbrella in a desired position and selectively unfix the position to choose a different position. The position of the umbrella holder is adjustable along the horizontal, vertical and diagonal. Certain embodiments provide a selectively releasable lock mechanism such as a releasable latch to fix the angle or other position of the armature in a desired position.

For vehicles such as vans that have sliding doors such that an internal mount would be problematic, the present umbrella holder is easily adapted for external mounting.

The selectively releasable suction mounting mechanism of the preferred embodiment is adaptable for mounting to any suitable smooth surface other than automobile window glass, such as metal, ceramic, plastic or even smooth, polished stone.

Alternative embodiments provide an umbrella holder that can be selectively mounted to a baby carrier-type car seat. With the carrier/car seat mounted embodiments, one can protect a baby from the elements in a hands-free fashion with than umbrella secured in an upright position over the carrier and then transfer the umbrella to the automobile holder when fastening the carrier in to the car seat.

Many modifications and other embodiments of the umbrella holder described herein will come to mind to one skilled in the art to which this disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. (canceled)

2. An umbrella holder for providing protection from inclement weather for a user positioned at least partially in a volume between a door of a vehicle wherein the door is in an opened position and an interior volume of the vehicle, the door defining an interior surface, the umbrella holder comprising:
an attachment device adapted to releasably attach to the vehicle door via the interior surface;
an articulable arm defining proximal and distal ends and being operably coupled with the attachment device at the proximal end; and
an umbrella receptacle adapted to receive a handle of an umbrella and being operably coupled with the articulable arm at the distal end wherein, when the door is in the opened position and the attachment device is releasably attached to the vehicle door via the interior surface, the articulable arm extends from a location generally adjacent to the interior surface of the vehicle door and into the volume between the vehicle door and the interior volume of the vehicle.

3. The umbrella holder of claim 1 wherein the articulable arm is further adapted to adjust a position of the umbrella receptacle along a direction selected from the group consisting of a horizontal direction and a vertical direction.

4. The umbrella holder of claim 3 wherein the articulable arm is further adapted to adjust the position of the umbrella receptacle along both the horizontal and vertical directions in one movement.

5. The umbrella holder of claim 1 wherein the articulable arm is further adapted to adjust the position of the umbrella receptacle along a diagonal direction.

6. The umbrella holder of claim 1 further comprising a locking assembly operably coupled to the articulable arm to fix the articulable arm in a position.

7. The umbrella holder of clam 1 further comprising a tightening assembly operably coupled to the umbrella receptacle and being adapted to releasably couple the umbrella handle and the umbrella receptacle.

8. The umbrella holder of claim 1 further comprising a plurality of articulable joints of the articulable arm.

9. An umbrella holder for providing protection from inclement weather for a user, the umbrella holder comprising:
an attachment device adapted to releasably attach to an object defining a surface;
an articulable arm defining proximal and distal ends and being operably coupled with the attachment device at the proximal end; and
an umbrella receptacle adapted to receive a handle of an umbrella and being operably coupled with the articulable arm at the distal end wherein the articulable arm extends from the attachment device to a user-adjustable position.

10. The umbrella holder of claim 9 wherein the articulable arm is further adapted to adjust a position of the umbrella receptacle along a direction selected from the group consisting of a horizontal direction and a vertical direction.

11. The umbrella holder of claim 10 wherein the articulable arm is further adapted to adjust the position of the umbrella receptacle along both the horizontal and vertical directions in one movement.

12. The umbrella holder of claim 9 wherein the articulable arm is further adapted to adjust the position of the umbrella receptacle along a diagonal direction.

13. The umbrella holder of claim 9 further comprising a locking assembly operably coupled to the articulable arm to fix the articulable arm in a user selected position.

14. The umbrella holder of clam 9 further comprising a tightening assembly operably coupled to the umbrella receptacle and being adapted to releasably couple the umbrella handle and the umbrella receptacle.

15. The umbrella holder of claim 9 further comprising a plurality of articulable joints of the articulable arm.

16. A method of providing protection from inclement weather for a user, the method comprising:
releasably attaching an umbrella holder to a surface of an object using an releasable attachment device;
placing an umbrella handle in an umbrella receptacle of the umbrella holder;
positioning the umbrella receptacle using an articulable arm of the umbrella holder which is operably coupled to the releasable attachment device at a proximal end of the articulable arm and which is operably coupled to the umbrella receptacle at a distal end of the articulable arm.

17. The method of claim 16 wherein the positioning of the umbrella receptacle is along a direction selected from the group consisting of a horizontal direction and a vertical direction.

18. The method of claim 17 wherein the positioning of the umbrella receptacle is along both the horizontal and vertical directions in one movement.

19. The method of claim 16 wherein the positioning of the umbrella receptacle is along a diagonal direction.

20. The method of claim 16 further comprising fixing the position of the articulable arm in a user selected position with a locking assembly.

21. The method of claim 20 further comprising releasing the articulable arm using the locking assembly and re-positioning the articulable arm.
